(19) United States
(12) Patent Application Publication
(10) Pub. No.: US 2025/0158342 A1
(43) Pub. Date: May 15, 2025

(54) MEASURING DEVICE FOR ADJUSTING A LASER BEAM

(71) Applicant: TRUMPF Lasersystems for Semiconductor Manufacturing GmbH, Ditzingen (DE)

(72) Inventors: Steffen Erhard, Korntal-Münchingen (DE); Torsten Steinbrueck, Waldstetten (DE); Jonathan Mueller, Stuttgart (DE)

(21) Appl. No.: 19/019,532

(22) Filed: Jan. 14, 2025

Related U.S. Application Data
(63) Continuation of application No. PCT/EP2023/069777, filed on Jul. 17, 2023.

(30) Foreign Application Priority Data
Jul. 18, 2022 (DE) 10 2022 207 308.8

(51) Int. Cl. H01S 3/00; G02B 27/09; G02B 27/10; G02F 1/33

(52) U.S. Cl. CPC H01S 3/0071; G02B 27/0927; G02B 27/0988; G02B 27/108; G02F 1/33; H01S 3/0014

(57) ABSTRACT

An optical apparatus for controlled forward routing of a laser beam includes an acousto-optical modulator for feeding through a forward-traveling laser beam and deflecting a backward-traveling laser beam, a spatial filter for the forward-traveling laser beam arranged downstream of the acousto-optical modulator with respect to the forward-traveling laser beam, and a measuring device arranged upstream of the spatial filter with respect to the forward-traveling laser beam. The measuring device is configured to image a near-field plane and a far-field plane of the forward-traveling laser beam onto a common target. The measuring device includes a first optical element and a second optical element. One of the first optical element and the second optical element being arranged in order to split a beam path of the forward-traveling laser beam into a near-field beam path and a far-field beam path, both of which being aligned with the target.

### CROSS REFERENCE TO RELATED APPLICATIONS

This application is a continuation of International Application No. PCT/EP2023/069777 (WO 2024/017829 A1), filed on Jul. 17, 2023, and claims benefit to German Patent Application No. DE 10 2022 207 308.8, filed on Jul. 18, 2022. The aforementioned applications are hereby incorporated by reference herein.

### FIELD

Embodiments of the present invention relate to an optical apparatus for controlled guidance of a laser beam. Embodiments of the present invention also relate to the use of a measuring device.

### BACKGROUND

In an EUV light source, a laser beam is generated by a seed laser and amplified by one or more amplifiers. The amplified laser beam is focused by a focusing unit onto a target that emits EUV radiation. However, the laser beam is reflected from the target and consequently passes through the amplifier chain back to the seed laser a second time. In particular if there is still population inversion in the laser-active medium of the amplifiers, it may be that the reflected laser beam is amplified on its way through the amplifier chain and optics designed for a lower-power laser beam are destroyed. To block the reflected backward-traveling laser beam, use is made, inter alia, of an acousto-optical modulator (AOM) that is switched in such a way that the reflected beam is guided into a beam trap, but the forward-traveling laser beam is fed through.

Ideally, the laser beam on its path from the seed laser to the target should be present as a Gaussian beam. However, the acousto-optical modulator changes the beam shape of the laser beam, and so, after passing through the acousto-optical modulator, the laser beam is no longer present as a Gaussian beam. After passing through the acousto-optical modulator, the laser beam is therefore guided through a spatial filter that filters out beam components of the laser beam which run transversely to a desired beam direction of the laser beam. After passing through the spatial filter, the laser beam is again (approximately) Gaussian. To avoid power losses, a main part of the laser beam should be routed through the spatial filter. This requires precise adjustment of the laser beam and, in particular, setting of the direction and position thereof before it passes through the spatial filter. Such adjustment can also be made in an automated manner, for example by moving a deflection mirror. At the same time, the presence of a multiplicity of optical elements required for controlled forward routing of the laser beam over a relatively large beam path means that there is only little installation space available.

### SUMMARY

Embodiments of the present invention provide an optical apparatus for controlled forward routing of a laser beam. The optical apparatus includes an acousto-optical modulator for feeding through a forward-traveling laser beam and deflecting a backward-traveling laser beam, a spatial filter for the forward-traveling laser beam arranged downstream of the acousto-optical modulator with respect to the forward-traveling laser beam, and a measuring device arranged upstream of the spatial filter with respect to the forward-traveling laser beam. The measuring device is configured to image a near-field plane and a far-field plane of the forward-traveling laser beam onto a common target. The measuring device includes a first optical element and a second optical element. One of the first optical element and the second optical element being arranged in order to split a beam path of the forward-traveling laser beam into a near-field beam path and a far-field beam path, both of which being aligned with the target.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic side view of an optical apparatus according to embodiments of the invention having a measuring device; and

FIG. 2 shows an enlarged and more detailed view, rotated through 90°, of the measuring device from FIG. 1, according to some embodiments.

### DETAILED DESCRIPTION

The precise adjustment of a laser beam, in particular in the EUV light source, is very complex in practice or requires the use of large measuring devices. This problem relates generally to optical apparatuses for guiding a laser beam that passes through an acousto-optical modulator and a spatial filter.

Embodiments of the invention can permit precise adjustment of a laser beam that passes through an acousto-optical modulator and a spatial filter.

Embodiments of the invention provide an optical apparatus for guiding a laser beam, the optical apparatus comprising at least one acousto-optical modulator and at least one spatial filter arranged downstream of the acousto-optical modulator. The optical apparatus furthermore comprises a measuring device, in particular between the acousto-optical modulator and the spatial filter. The measuring device comprises at least a first optical element and a second optical element. The two optical elements are configured to jointly image a near-field plane and a far-field plane of the laser beam on a target. To this end, at least one of the optical elements is designed to split the beam path of the laser beam into a near-field beam path and a far-field beam path, both of which point toward the target.

In order to guide the laser beam through the spatial filter with the lowest possible power losses, the laser beam is thus measurable using the measuring device before passing through the spatial filter, and the position of the spatial filter is accordingly adaptable. In particular, the position and pointing (direction) of the forward-traveling laser beam can be determined in the measuring device and this information can be used for adjusting the apparatus.

The first optical element may be part of a group of first optical elements and/or the second optical element may be part of a group of second optical elements. The use of multiple optical elements allows optical aberrations to be significantly reduced.

In a further preferred configuration of the apparatus, the first optical element has a positive refractive power. As an alternative or in addition thereto, the second optical element can have a negative refractive power. The measuring device can therefore be produced in a particularly space-saving form.

The measuring device can be produced in a simple design if the first optical element is in the form of a lens and/or the second optical element is in the form of a lens.

The near-field beam path is preferably produced by the second optical element by direct transmission of the laser beam. The far-field beam path is preferably produced by at least two reflections of the laser beam from surfaces of the second optical element.

In order to keep the first optical element at least largely reflection-free, the first optical element can have an antireflection coating, preferably on two mutually opposite surfaces. The second optical element can be uncoated or partially reflectively coated.

The second optical element is preferably arranged between the target and the first optical element.

In order to facilitate adjustment of the laser beam, the target can be in the form of a camera, in particular in the form of a camera sensor.

More preferably, the apparatus comprises a beam splitter for decoupling an, in particular small, part of the laser beam into the measuring device. The beam splitter can be in the form of a semitransparent mirror.

The spatial filter can be realized in a simple design if it is in the form of a pinhole diaphragm.

The apparatus can comprise a beam trap into which the acousto-optical modulator can route reflected laser beams.

In a preferred embodiment of the invention, the apparatus has a seed laser and/or at least one amplifier, in particular multiple amplifiers. One of the amplifiers can be a preamplifier that is arranged upstream of the acousto-optical modulator from the point of view of the forward-traveling laser beam. Such an arrangement prevents the backward-traveling laser beam from reaching the preamplifier, and so the backward-traveling laser beam cannot be amplified further in the preamplifier and is incident on the acousto-optical modulator with a lower power.

The apparatus can furthermore be designed to generate EUV radiation. It can comprise a target, in particular in the form of a droplet of tin, that can be irradiated by the laser beam. The apparatus can comprise a focusing unit for focusing the laser beam onto the target.

Embodiments of the invention also relate to the use of a measuring device in an apparatus for generating EUV radiation. The apparatus comprises the following:
a seed laser and at least one amplifier for generating a laser beam;
a target for generating EUV radiation, which target can be irradiated by the laser beam;
a spatial filter arranged upstream of the target;
an acousto-optical modulator arranged downstream of the amplifier and upstream of the spatial filter.

The measuring device is used for measuring and adjusting the laser beam. The measuring device comprises at least a first optical element and a second optical element. The two optical elements are configured to jointly image a near-field plane and a far-field plane of the laser beam on a target. To this end, at least one of the optical elements is designed to split the beam path of the laser beam into a near-field beam path and a far-field beam path, both of which point toward the target.

In particular, the position and pointing (direction) of the forward-traveling laser beam are determined in the measuring device and this information is used for adjusting the apparatus.

All features described above for the apparatus can be employed when using the measuring device.

Exemplary embodiments of the invention are described below with reference to the drawing. It is possible for the abovementioned features and the features mentioned below to be used individually by themselves or for multiple features to be used in any desired combinations. The embodiments shown and described should not be understood as an exhaustive list, but rather they have an exemplary character.

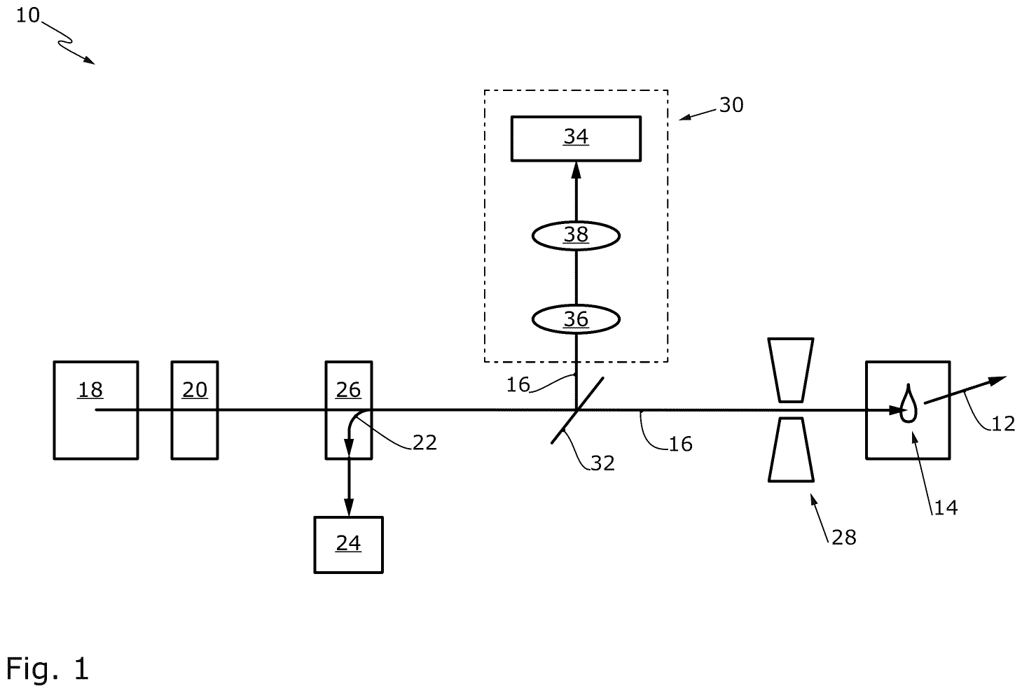

FIG. 1 shows an optical apparatus 10 for generating EUV radiation 12 by irradiating a target 14, here in the form of a droplet of tin, with a forward-traveling laser beam 16. The forward-traveling laser beam 16 is generated in a laser source 18 in the form of a seed laser and amplified in at least one amplifier 20. Preferably, there is provision for multiple amplifiers 20.

The forward-traveling laser beam 16 can be reflected from the target 14 and damage the laser source 18. In order to divert a backward-traveling laser beam 22, produced by reflection, such as this into a beam trap 24, there is provision for an acousto-optical modulator 26. The forward-traveling laser beam 16 is pulsed. The deflection angle of the acousto-optical modulator 26 is time-dependent given appropriate acoustic excitation, and so a pulse of the forward-traveling laser beam 16 has a time offset with respect to a pulse of the backward-traveling laser beam 22, and the pulse of the backward-traveling laser beam 22 experiences a different deflection angle than the pulse of the forward-traveling laser beam 16.

However, the acousto-optical modulator 26 changes the beam shape of the forward-traveling laser beam 16. There is therefore provision for a spatial filter 28 in order to limit the forward-traveling laser beam 16 to its, at least approximately, Gaussian part. The spatial filter 28 is preferably in the form of a pinhole diaphragm.

The amplifier(s) 20 may be arranged downstream or upstream of the acousto-optical modulator 26 with respect to the forward-traveling laser beam 16. In particular, an amplifier 20 may be arranged upstream of the acousto-optical modulator 26, while further amplifiers are arranged downstream of both the acousto-optical modulator 26 and the spatial filter 28.

The forward-traveling laser beam 16 can be optimally adjusted for the spatial filter 28 using a measuring device 30. There can be provision for a beam splitter 32 in order to route a small proportion of the forward-traveling laser beam 16 into the measuring device 30. The beam splitter 32 is arranged between the acousto-optical modulator 26 and the spatial filter 28.

The measuring device 30 comprises a target 34, here in the form of a camera, a first optical element 36 and a second optical element 38. The second optical element 38 is arranged between the first optical element 36 and the target 34.

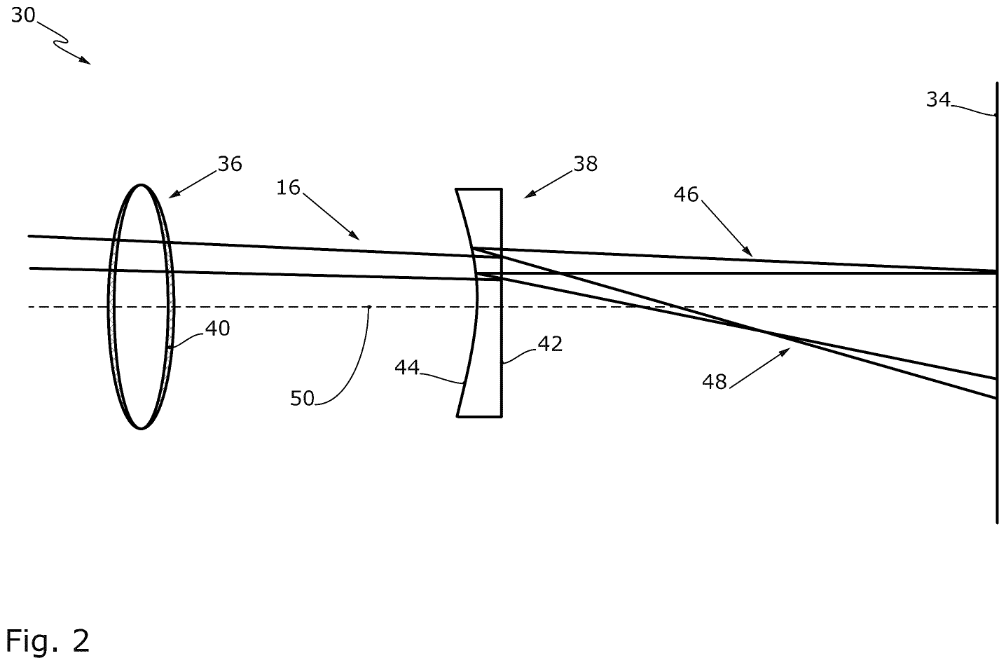

FIG. 2 shows the measuring device 30 with the first optical element 36, the second optical element 38 and the target 34. The first optical element 36 is preferably in the form of a transparent lens having positive refractive power, and the second optical element 38 is preferably in the form of a transparent lens having negative refractive power. The first optical element 36 can have an antireflection coating 40; the second optical element 38 preferably does not have an antireflection coating or a partially reflective coating.

The second optical element 38 has a first surface 42 and a second surface 44, the first surface 42 being arranged downstream of the second surface 44 with respect to the forward-traveling laser beam 16. The second optical element 38 produces a near-field beam path 46 by direct transmission of the forward-traveling laser beam 16. Furthermore, the optical element 38 produces a far-field beam path 48 by reflections from the first surface 42 and the second surface 44.

The measuring device 30 has an optical axis 50. The optical axis 50 can extend centrally through the first optical element 36. The forward-traveling laser beam 16 can be routed through the measuring device 30 in a manner offset with respect to the optical axis 50. As an alternative or in addition thereto, the second optical element 38 is preferably arranged in a manner offset or tilted with respect to the optical axis 50.

The measuring device 30 provides a precise but nevertheless simply designed and space-saving way of adjusting the forward-traveling laser beam 16, in particular with regard to the spatial filter 28 and/or the acousto-optical modulator 26. In particular, the partially reflecting surfaces produce multiple images that correspond to different imaging planes as a result of the different optical paths. It is thus possible to determine not only the beam position at the beam splitter 32 but also the angle of the forward-traveling laser beam 16 (and thus the beam position at other positions).

Looking at both figures of the drawing together, embodiments of the invention relate to an optical apparatus 10, in particular for generating EUV radiation 12, having a measuring device 30. Embodiments of the invention also relate to the use of a measuring device 30 in an optical apparatus 10 for generating EUV radiation 12. The measuring device 30 comprises at least two optical elements 36, 38 that separate a near-field beam path 46 from a far-field beam path 48 and image both a near-field plane and a far-field plane on a target 34. The far-field beam path 48 is preferably produced in a reflection-free manner, and the near-field beam path is preferably produced by multiple reflection, in particular in only one of the optical elements 36, 38.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### List of Reference Signs

10 optical apparatus
12 EUV radiation
14 target
16 forward-traveling laser beam
18 laser source
20 amplifier
22 backward-traveling laser beam
24 beam trap
26 acousto-optical modulator
28 spatial filter
30 measuring device
32 beam splitter
34 target
36 first optical element
38 second optical element
40 antireflection coating
42 first surface of the second optical element 38
44 second surface of the second optical element 38
46 near-field beam path of the forward-traveling laser beam 16
48 far-field beam path of the forward-traveling laser beam 16
50 optical axis of the measuring device 30

1. An optical apparatus for controlled forward routing of a laser beam, the optical apparatus comprising:
an acousto-optical modulator for feeding through a forward-traveling laser beam and deflecting a backward-traveling laser beam;
a spatial filter for the forward-traveling laser beam, arranged downstream of the acousto-optical modulator with respect to the forward-traveling laser beam; and
a measuring device arranged upstream of the spatial filter with respect to the forward-traveling laser beam, the measuring device being configured to image a near-field plane and a far-field plane of the forward-traveling laser beam onto a common target, the measuring device comprising a first optical element and a second optical element, one of the first optical element and the second optical element being arranged in order to split a beam path of the forward-traveling laser beam into a near-field beam path and a far-field beam path, both of which being aligned with the target.

2. The optical apparatus as claimed in claim 1, further comprising:
a first group of optical elements, the first optical element being part of the first group of optical elements; and/or
a second group of optical elements, the second optical element being part of the second group of optical elements.

3. The apparatus as claimed in claim 1, wherein the first optical element has a positive refractive power, and/or the second optical element has a negative refractive power.

4. The apparatus as claimed in claim 1, wherein the first optical element and/or the second optical element is/are comprises a lens.

5. The apparatus as claimed in claim 1, wherein the second optical element is light-transmissive, the near-field beam path is capable of being produced by the second optical element by direct transmission of the forward-traveling laser beam, and the far-field beam path is capable of being produced by a first reflection from a first surface of the second optical element and a second reflection from a second surface of the second optical element.

6. The apparatus as claimed in claim 1, wherein the first optical element is antireflection-coated and/or the second optical element is uncoated or partially reflectively coated.

7. The apparatus as claimed in claim 1, wherein the second optical element is arranged downstream of the first optical element with respect to the forward-traveling laser beam.

8. The apparatus as claimed in claim 1, wherein the common target comprises a camera.

9. The apparatus as claimed in claim 1, further comprising a beam splitter for decoupling a part of the forward-traveling laser beam into the measuring device.

10. The apparatus as claimed in claim 1, wherein the spatial filter comprises a pinhole diaphragm.

11. The apparatus as claimed in claim 1, further comprising a beam trap, the acousto-optical modulator being configured to deflect the backward-traveling laser beam into the beam trap.

12. The apparatus as claimed in claim 1, further comprising a seed laser and an amplifier for generating the forward-traveling laser beam.

13. The apparatus as claimed in claim 1, further comprising a target for generating EUV radiation, wherein the target is capable of being irradiated by the forward-traveling laser beam.

14. An apparatus for generating EUV radiation, the apparatus comprising:
a seed laser and an amplifier for generating a forward-traveling laser beam;
a target for generating the EUV radiation, the target is capable of being irradiated by the forward-traveling laser beam;
a spatial filter arranged upstream of the target with respect to the forward-traveling laser beam;
an acousto-optical modulator for feeding through the forward-traveling laser beam and deflecting a backward-traveling laser beam, the acousto-optical modulator arranged downstream of the amplifier with respect to the forward-traveling laser beam and upstream of the spatial filter; and
a measuring device configured to adjust the apparatus for the spatial filter with respect to the forward-traveling laser beam, the measuring device being configured to image a near-field plane and a far-field plane of the forward-traveling laser beam onto a common target, the measuring device comprising a first optical element and a second optical element, one of the first optical element and the second optical element being arranged in order to split a beam path of the forward-traveling laser beam into a near-field beam path and a far-field beam path, both of which being aligned with the common target.
